(19) United States
(12) Patent Application Publication
(10) Pub. No.: US 2005/0211191 A1
(43) Pub. Date: Sep. 29, 2005

(54) Adjustable hobble

(76) Inventor: Richard C. Kleinhardt, Clare, MI (US)

Correspondence Address: DICKINSON WRIGHT PLLC, 1901 L. STREET NW, SUITE 800, WASHINGTON, DC, 20036, US

(21) Appl. No.: 11/059,459

(22) Filed: Feb. 16, 2005

Related U.S. Application Data
(60) Provisional application No. 60/546,371, filed on Feb. 20, 2004.

(51) Int. Cl. A01K 27/00

(52) U.S. Cl. 119/819

(57) ABSTRACT

An improved hobble for use on cows and horses includes a lightweight construction to provide comfort to the animals, yet durability for wear and rust resistance. A hobble is provided that is easy to apply and remove from the animals, easy to keep clean and is a humane and safe product for use on animals. A hobble further provides enhanced adjustability to accommodate the specific size, breed, and need. The adjustability features permit the hobble to be used for therapeutic cases, such as difficult calving, as well as for training purposes by providing an anti-kicking device for taming animals. The full adjustability feature also allows for application in narrow settings to prevent cows from pawing in their stalls. A cushioning inner layer of the leg straps and coating of a light reflective material add to an animal's comfort and night-time visibility.

### BACKGROUND OF THE INVENTION

1. Field of the Invention

The present invention relates to a hobble and particularly to an adjustable lightweight hobble for use with hoofed animals such as cows and horses.

2. Discussion of Related Art

Hobbles, used for limiting the mobility of animals by connecting two feet to each other through the use of a pair of cuffs attached to the animal's legs, are well known in the art. See, for example, U.S. Pat. No. 914,059 issued Mar. 2, 1909 and U.S. Pat. No. 5,092,276 issued Mar. 3, 1992. Typically, hobble cuffs are strapped just above the dewclaws of a cow or above the hoof and below the fetlock of a horse and are then linked by a chain, rope or leather strap to curtail mobility. A hobble may be positioned on either the front two legs or the rear two legs. The concept of hobbling has been around for years. There have been many attempts to hobble an animal with a variety of different products that may be available to the user. One function of a hobble is to prevent a cow from splitting out. To achieve this, there must be sufficient distance between the two cuffs. Also, cows that have nerve damage as a result of difficult calving may need to be stabilized. The longer distance between cuffs enables an injured animal to walk more freely, while preventing the animal from a split pelvis injury. The longer distance also allows her to rise after lying down more easily. Another fundamental function of a hobble is to dramatically reduce the mobility of an animal's leg movements. For some individual cows, this is mandatory in the milking process. By shortening the distance between the cuffs the possibility of kicking of an attendant who is milking the cow can be virtually eliminated. Many animals have been broke through this process, while others have learned to wear a hobble for long periods of time.

Hobbles are also used as a humane training tool for horses to teach them the concept of control and discipline. They are also used as an anti-kicking device to curtail kicking when placed on rear legs. Typically, horses that are broke using a hobble will remain calm if they get caught in wire or other restraining mechanisms. Horses also learn to ground tie easily if broke to hobble. Horsemen extensively use hobbles on horses to graze (grazing hobble) as well as picketing a horse (picket hobble).

Because there are many different uses of a hobble and there are many different sized animals to be hobbled, there is a desire and need in the art for an adjustable hobble to accommodate the various sizes, types and breeds of animals. There is also a need in the art for an improved lightweight hobble constructed of lightweight, yet durable materials to provide improved comfort to the animal.

### SUMMARY OF THE INVENTION

Accordingly, the present invention provides an improved hobble that can be configured for use on cows, horses and other hoofed animals. The adjustable hobble of the present invention includes a lightweight construction to provide comfort to the animals, yet durability for wear and rust resistance. The present invention also provides a hobble that is easy to apply and remove from the animals, easy to keep clean and is a humane and safe product for use on animals.

The present invention further provides enhanced adjustability to accommodate specific needs. The adjustability features permit the hobble to be used for therapeutic cases, for example, difficult calving as well as for training purposes by providing an anti-kicking device for taming animals. The full adjustability feature also allows for application in narrow settings to prevent pawing by the animals in animal stalls. The invention provides humane treatment while an animal is hobbled.

The present invention provides numerous additional important advantages such as saving valuable dairy animals from nerve damage related to calving by placement of the hobble on a wide setting attached on rear legs above the dewclaws to prevent splitting, thus enabling early return of animals to productivity. Another advantage is the enabling of a user to handle obstinate dairy animals that could kick by attaching the hobble in a narrow setting on rear legs above the dewclaws. An animal can be prevented from pawing for example, by attachment to the front legs of a cow above the dewclaws or attachment to the front legs of a horse above the hoof and below the fetlock.

Training or breaking horses is facilitated by use of a narrow setting applied to front legs above the hoof and below the fetlock. Horses can be allowed to graze by use of wider settings when the hobble is applied to front legs above the hoof and below the fetlock. Thus, as already noted, the hobble may be customized to accommodate specific needs, breeds and animal species by simple adjustment of the hobble.

A further advantage of the invention is the provision of a product that is strong, durable, and resistant to rot, rusting or other deterioration or corrosion. Also, the device is easy to clean and machine washable. Dependable performance and ease of adjustment of the hobble are enhanced by use of a positive lock buckle assembly as well as a slide buckle allowing adjustment when attached to the animal. Thus the hobble provides the ability to easily and quickly change mobility function at the animal's side using the slide buckle.

Other features of the present invention will become more apparent to persons having ordinary skill in the art to which the present invention pertains from the following description and claims taken in conjunction with the accompanying figures.

### BRIEF DESCRIPTION OF THE FIGURES

The foregoing features, as well as other features, will become apparent with reference to the description and figures below, in which like numerals represent like elements, and in which:

FIG. 1 is a top view of an embodiment of a hobble of the present invention showing a cuff on one side in an open position and the cuff on the opposite side in a closed position and an unseparable center strap;

FIG. 2 is a top view of another hobble of the present invention with a separable center strap;

FIG. 3 is a top view of the hobble of FIG. 2 with both sides in the closed position; and

FIG. 4 is a perspective view of the hobble of FIG. 2 in the closed position.

### DETAILED DESCRIPTION OF THE INVENTION

The hobble of the present invention is strong, lightweight, easy to attach and humane to animals. The hobble preferably is constructed of high tensile strength nylon webbing (preferably 8 oz. for horses and 12 oz. for cows) and has stainless steel components. The hobble further offers a full range of adjustability not only around the animal's legs, but also for the spacing between the animal's legs. By virtue of the range of adjustability of the hobble of the present invention the hobble may be used on an animal's front legs or an animal's back legs or any combination of a leg or a foot. This versatility may be desired for use of the hobble for varying purposes. For example, typically wider settings between the animal's legs are used for therapeutic uses, while narrow settings are used for disciplinary restraint. A cushioning lining, for example neoprene or rubber, may be included to provide a cushioning effect to an animal's legs.

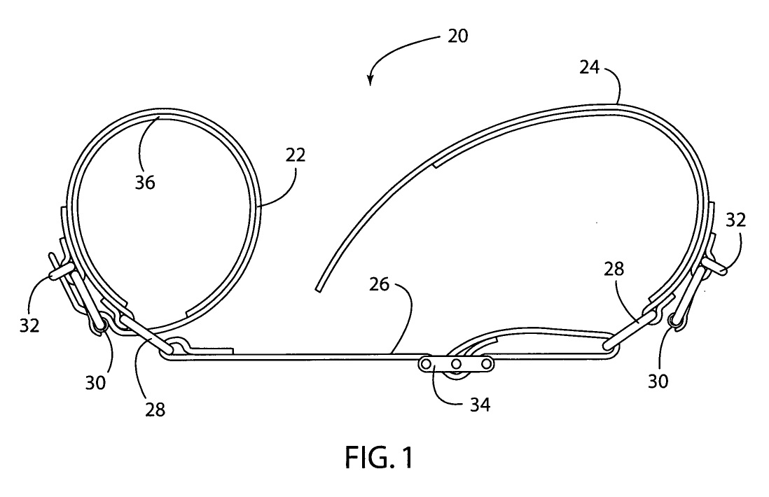

Turning now to the figures, an embodiment of a hobble 20 of the present invention may include a first leg strap 22 and a second leg strap 24 as shown in FIG. 1. First leg strap 22 and second leg strap 24 may be constructed with Nylon webbing preferably having a 2722 kilograms-force (6000 pound-force) tensile strength. Hardware components providing a positive lock buckle system, similar to a typical belt worn by humans, and maybe attached to first and second leg straps 22 and 24. Specifically, a receiving buckle 30 and a strap retainer 32 may be connected to first and second leg straps 22 and 24 as shown in FIGS. 1-4. A ring element 28, which may be D-shaped, may also be connected to first and second leg straps 22 and 24 by a variety of known attachment means, such as being sewn onto an end of leg straps 22 and 24 as shown in the figures. Likewise, receiving buckle 30 and strap retainer 32 may be attached using any of a variety of attachment methods well known in the art. Having a positive lock buckling system allows for easy-on easy-off usage and adjustment to fit the leg size of the particular animal. Ring element 28, receiving buckle 30 and strap retainer 32 are preferably constructed with stainless steel to resist rust, as the hobble 20 will be exposed to weather elements and acidic conditions.

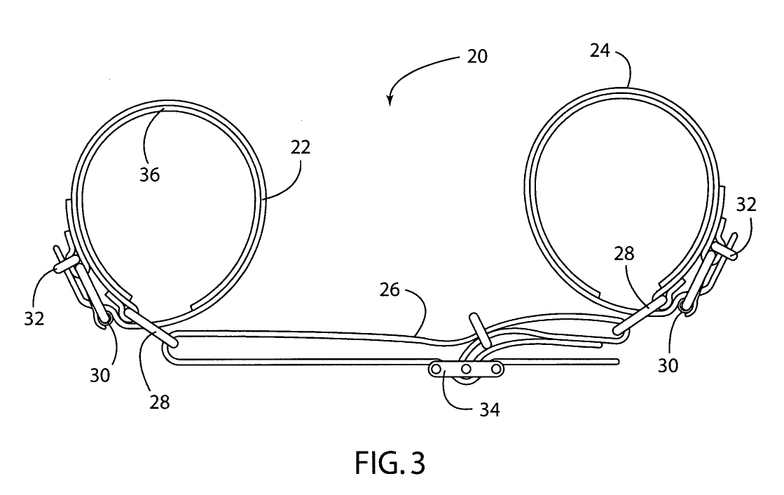

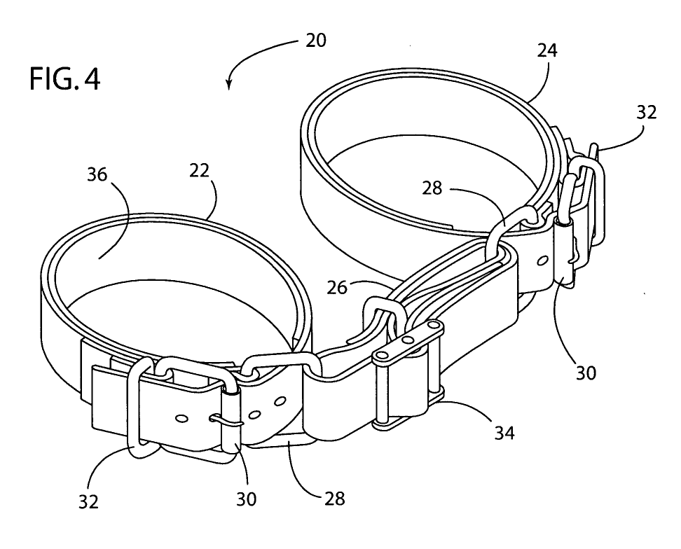

An unseparable center strap 26 may be adjustably connected to first leg strap 22 and second leg strap 24 as shown in FIG. 1. A slide buckle 34 may be slidably attached to center strap 26 to provide sliding adjustment to the length of center strap 26. Such adjustment slides are known in the art. The hobble 20 of the present invention may preferably provide an adjustment of center strap 26 typically ranging from 30.48 to 53.34 cm (12-21 inches) for cows (see FIG. 3) and 10.16 to 30.48 cm (4-12 inches) for horses (see FIG. 4). This allows a user to obtain a customized fit for the specific need, size and breed. As with the hardware components included on leg straps 22 and 24, slide buckle 34 is also preferably constructed with stainless steel to provide rust resistance properties.

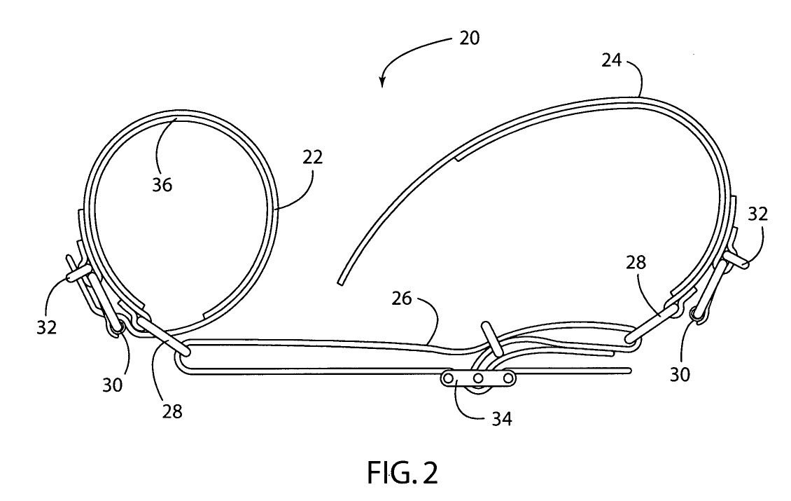

In another embodiment of the present invention, hobble 20 may also include a liner 36 positioned on an inside surface of first and second leg straps 22 and 24 as shown in FIGS. 2 and 4. Liner 36 may be attached using conventional attachment means, such as adhesive, hook and loop fasteners such as those sold under the trade name VELCRO, snaps or any other suitable method, and may preferably be constructed with a neoprene material to provide further comfort to the animal. It is to be noted, however, that liner 36 may alternatively include a variety of different suitable materials. Liner 36 provides cushioning to the legs of the animal, which reduces the potential for irritation to the animal. Also, this embodiment shows separable center strap 26 configuration. This separable feature is useful to remove center strap 26 while leaving first and second leg straps 22 and 24 in place. This feature could be useful if first and second leg straps 22 and 24 are coated with a light reflective material (not shown) allowing the animal to move around un-hobbled while also adding an element of increased visibility if the animal strays into night-time traffic.

An important feature of the present invention is the multiple adjustment capabilities. Hobble 20 may be adjusted to fit the desired breed, size and need. For example, as the variability in size relating to horses is quite large, the present invention provides adjustability not only for the diameter of the horse's individual legs, but also the “foot print” width of the horse. In use, the first and second leg straps 22 and 24 may be slid through the slip buckle to custom tailor hobble 20 to the desired size, allowing for use on ponies, regular size horses or draught breeds. In addition, as the distance between the front legs of a horse is rather narrow, center strap 26 may be adjusted to this smaller width for further versatility of hobble 20. A narrow setting may be desired for use as a training hobble or a wider or lengthened setting may be desired for use as a grazing hobble. Another aspect of the present invention is that the hobble allows for complete separation of first and second leg straps 22 and 24 by removing center strap 26. This creates two picket hobbles.

In use, this invention provides the flexibility to those skilled in the industry to change, with one device, the rate of mobility granted to an animal whether it be maximum control through severe limited mobility, i.e., a training device; or minimum control through moderate mobility that allows an animal to recover from an injury or have the ability to graze without escape.

While the invention has been described in conjunction with specific embodiments and as further shown in the attachments, it is evident that many alternatives, modifications and variations will be apparent to those skilled in the art in light of the foregoing description. Accordingly, the present invention attempts to embrace all such alternatives, modifications and variations that fall within the spirit and scope of the appended claims.

1. An animal hobble device adapted to be installed around at least one leg of an animal, comprising:
a first strap provided with means to adjustably fix said strap into a selected length;
second and third leg straps connected at opposite ends of said first strap, said second and third straps each being provided with means to fix said straps into closed loops having adjustable circumferences and being adapted for being positioned around a leg of a hoofed animal.

2. An animal hobble device according to claim 1 wherein said first strap is in the form of a loop and said second and third straps are attached to opposite sides of said loop.

3. An animal hobble device according to claim 1, wherein at least one of said straps is formed of canvas webbing.

4. An animal hobble device according to claim 3, wherein said canvas webbing has 2722 kilograms-force tensile strength.

5. An animal hobble device according to claim 1, wherein said second and third straps are each adjustable by means of a buckle and wherein said straps are provided with a plurality of holes each adapted to receive a tongue associated with said buckle.

6. An animal hobble device according to claim 1, wherein said second and third leg straps further comprise a cushioning inner layer.

7. An animal hobble device according to claim 1 wherein said first strap is seperable.

8. An animal hobble device according to claim 1 wherein said second and third straps further comprise a coating of a light reflective material.

9. An animal hobble device according to claim 1, wherein said first strap is separable, and said second and third straps further comprise a cushioning inner layer and a coating of a light reflective material.
